(19) United States
(12) Patent Application Publication
(10) Pub. No.: US 2026/0116795 A1
(43) Pub. Date: Apr. 30, 2026

(54) HIGH-RATE SETTLING CLARIFIER WITH INCREASED TURN DOWN CAPABILITIES

(71) Applicant: SUEZ INTERNATIONAL, Paris (FR)

(72) Inventors: Richard UBALDI, Richmond, VA (US); Mark OWENS, Richmond, VA (US); Eduardo BERGMAN, Richmond, VA (US)

(73) Assignee: SUEZ INTERNATIONAL, Paris (FR)

(21) Appl. No.: 17/772,751

(22) PCT Filed: Oct. 31, 2019
(86) PCT No.: PCT/US2019/058981

§ 371 Date: Apr. 28, 2022

(51) Int. Cl. C02F 1/52; B01D 21/00; B01D 21/01; B01D 21/04; B01D 21/28

(52) U.S. Cl. CPC C02F 1/5281; B01D 21/0045; B01D 21/01; B01D 21/04; B01D 21/28; C02F 2209/40; C02F 2301/024

(57) ABSTRACT

In general, the present invention is directed to a system fort. the treatment of water or wastewater, wherein the system is designed for a maximum flow rate, the system including two or more reactor tanks, the two more reactor tanks each having a capability less than the maximum flow rate, and having a combined capability of achieving or exceeding the maximum flow rate, each reactor tank being fluidically connected to a clarification tank, the reactor tanks receiving an influent, and outputting an effluent; and a clarification tank designed to achieve or exceed, the maximum flow rate, the clarification tank receiving the effluent from the two or more reactor tanks.

### FIELD OF THE INVENTION

In general, the present invention is directed to high-rate settling clarifiers with increased turn-down capabilities. More specifically, the present invention is directed high-rate settling clarification treatment systems that may utilize multiple reactor tanks in fluidic communication with a single clarification/thickening tank.

### BACKGROUND

High-mate settling clarifiers have been in use for several years, Such clarifiers often combine solids contact, and solids recirculation to provide enhanced, high-rate settling of solids. Such systems, which may also be referred to as optimized flocculation using internal and external sludge recirculation systems, generally comprise a coagulation tank, a flocculation/maturation reactor, and a clarifier/thickener.

Each of these systems operates to provide high-rate solids contact clarification. Applications for such systems may include, but are not limited to combined sewer or sanitary sewer overflows, reduction of biological or chemical oxygen demand, reduction of total suspended solids, removal of phosphorous, reclamation of wastewater, clarification and softening, organics removal, silica removal, metal precipitation, treatment of wastewater from flue gas desulfurization, etc. With a variety of applications, flexibility of such a system to particularly desirable.

However, such systems may present several drawbacks. First systems are generally designed for maximum flow conditions. In applications such as combined sewer overflow/sanitary sewer overflows, this maximum flow—while needed in capabilities—may not represent typical operating parameters. In addition, there are circumstances where a system or facility is installed with the intention of overall growth in treatment capacity. In these circumstances, systems may again be designed for what is anticipated to be the maximum flow in the future, but again may not be achieved—or necessary for some period of time.

Turndown capacity—that is the effective operating range, or ratio between the maximum amount of water or wastewater that can be treated and the minimum amount—is generally a function of maximum flow. Turndown capacity is generally limited to approximately 50% of maximum design flow, due to a required velocity in the piston reactor necessary or desirable to achieve effect treatment. Such velocity generally maintains solids suspension until the flow reaches the clarification/thickener zone. Accordingly, when a system is designed for high maximum flow circumstances, the turndown capability of the system may be significantly limited. Moreover, because maximum flow conditions may occur rarely or periodically, the performance and efficacy of the entire system may be less than desirable during typical use.

In addressing this drawback, it has been known to install multiple systems. For example, if a maximum desired flow is X, two (2) systems may be installed each with maximum flow of 0.5(X). However, both systems need to be routinely used to avoid becoming septic or clogging due to sludge. In this circumstance, must be taken to routinely and consistently alternate flow between each system, However, the added capital expenditures and operating expenditures of two different systems, coupled with the additional care required during operation generally negates advantage provided by such multiple systems.

Accordingly, it is desirable to provide high-rate solids contact clarification systems with an increased range of turn down. Moreover, it is desirable to provide high-rate solids contact clarification systems that may provide for additional capacity when needed in the future, without impairing the current operation of the system.

### SUMMARY OF THE INVENTION

Some aspects in accordance with some embodiments of the present invention may include a system for the treatment of water or wastewater, comprising: two or more reactor tanks, each reactor tank being fluidically connected to a clarification tank, the reactor tanks each performing the same function of receiving an influent and inducing flocculation in the waste or wastewater, and outputting an effluent; and a clarification tank, the clarification tank receiving the effluent from the two or more reactor tanks, wherein flocs in the water or wastewater settle to the bottom of the clarification tank and clarified water and thickened sludge are removed from the system.

According to non-limited embodiments of the present invention, the system may comprise one or more of the following characteristics:
a coagulation tank in fluid communication with the two or more reactor tanks, the coagulation tank providing introduction of a coagulant to the water or wastewater and mixing;
two or more reactor tanks comprise a means for inducing turbulence into the water or wastewater in each reactor tank;
the clarification tank comprises a floor scraper to thicken flocs that have settled to the bottom of the clarification tank into sludge;
at least some of the sludge is recirculated to the two or more reactor tanks;
the clarification tank comprises sloping lamellae; and/or
each of the two or more reactor tanks is fluidically connected to the clarification tank by a transition chute.

Some aspects in accordance with some embodiments of the previous invention may include a system for the treatment of water or wastewater, wherein the system is designed for a maximum flow rate, the system comprising: two or more reactor tanks, the two more reactor tanks each having a capability less than the maximum flow rate, and having a combined capability of achieving or exceeding the maximum flow rate, each reactor tank being fluidically connected to a clarification tank, the reactor tanks receiving an influent, and outputting an effluent; and a clarification tank designed to achieve or exceed the maximum flow rate, the clarification tank receiving the effluent from the two or more reactor tanks.

According to non-limited embodiments of the present invention, the system may comprise one or more of the following characteristics:
the two or more reactor tar is each perform the same function of inducing flocculation in the water or wastewater, and wherein in the clarification tank flocs in the water or wastewater settle to the bottom of the clarification tank and clarified water and thickened sludge are removed from the system.

Some aspects in accordance with some embodiments of the present invention may include a system for the treatment of water or wastewater, wherein the system is designed for a maximum flow rate, the system comprising: a coagulation tank in fluid communication with two or more reactor tanks, the coagulation tank providing introduction of a coagulant to the water or wastewater and mixing; two or more reactor tanks, providing introduction of a flocculating agent to the two more reactor tanks each having a capability less than the maximum flow rate, and having a combined capability of achieving or exceeding the maximum flow rate, each reactor tank being fluidically connected to clarification tank via a transition chute and each reactor tank comprising a means for inducing turbulence to the water or wastewater, the reactor tanks each performing the same function of receiving an influent and inducing flocculation in the water or wastewater, and outputting an effluent; a clarification tank having a capability to process waste or wastewater at or above the maximum flow rate, the clarification tank receiving the effluent from the two or more reactor tanks, wherein flocs in the water or wastewater settle to the bottom of the clarification tank and clarified water is removed from the system, the clarification tank comprising sloping lamella and a floor scraper to thicken flocs that have settled to the bottom of the clarification tank into sludge; and a sludge recirculation conduit configured to recirculate at least some of the sludge from the clarification tank to the two or more reactor tanks.

Some aspects in accordance with some embodiments of the present invention may include a method of controlling a system for the treatment of water or wastewater designed for a maximum flow rate, the system comprising two reactor tanks each having a capability less than the maximum flow rate, and having a combined capability of achieving or exceeding the maximum flow rate and a clarification tank having a capability to process water or wastewater at or above the maximum flow rate, the method comprising: determining the incoming flow rate of an influent provided to the system; upon determination that the incoming flow rate is less than 50% the maximum flow rate, providing the influent to one reactor tank; upon a determination that the incoming low rate is greater than 50% the maximum flow rate, dividing the influent and providing influent to each of the reactor tanks; outputting an effluent from the reactor tank or tanks used to a clarification tank; and receiving at a clarification tank the effluent from the reactor tank or tanks used and outputting treated water or wastewater from the system.

These and other aspects will become apparent from the following description of the invention taken in conjunction with the following drawings, although variations and modifications may be affected without departing from the scope of the novel concepts of the invention.

### BRIEF DESCRIPTION OF THE DRAWINGS

The present invention can be more fully understood by reading the following detailed description together with the accompanying drawings, in which like reference indicators are used to designate like elements. The accompanying figures depict certain illustrative embodiments and may aid in understanding the following detailed description. Before any embodiment of the invention is explained in detail, it is to be understood that the invention is not limited in its application to the details of construction and the arrangements of components set forth in the following description or illustrated in the drawings. The embodiments depicted are to be understood as exemplary and in no way limiting of the overall scope of the invention. Also, it is to be understood that the phraseology and terminology used herein is for the purpose of description and should not be regarded as limiting. The detailed description will make reference to the following figures, in which:

FIG. 1 illustrates a high-rate settling clarification system, as known in the prior art.

FIG. 2 depicts a high-rate settling clarification system, as known in the prior art.

FIG. 3 depicts a high-rate settling clarification system, as known in the prior art.

FIG. 4 illustrates an exemplary high-rate turn down treatment system, in accordance with some embodiments of the present invention.

FIG. 5 illustrates an exemplary high-rate turn down treatment system, in accordance with some embodiments of the present invention.

FIG. 6 illustrates exemplary high-rate turn down treatment system, in accordance with some embodiments of the present invention.

FIG. 7 illustrates an exemplary high-rate turn down treatment system, in accordance with some embodiments of the present invention.

FIG. 8 illustrates an exemplary control sequence for an illustrative a high-rate turn down treatment system comprising multiple reactors, in accordance with some embodiments of the present invention.

FIG. 9 illustrates exemplary control sequence for an illustrative illustrates a high-rate turn down treatment system comprising multiple reactors, in accordance with some embodiments of the present invention.

FIG. 10A and 10B illustrate space-saving advantages of exemplary high-rate turn down treatment system comprising multiple reactors in accordance with some embodiments of the present invention compared with traditional systems.

Before any embodiment of the invention is explained in detail, it is to be understood that the present invention is not limited in its application to the details of construction and the arrangements of components set forth in the following description or illustrated in the drawings. The present invention is capable of other embodiments and of being practiced or being carried out in various ways. Also, it is to be understood that the phraseology and terminology used herein is the purpose of description and should not be regarded as limiting.

### DETAILED DESCRIPTION

The matters exemplified in this description are provided to assist in a comprehensive understanding of various exemplary embodiments disclosed with reference to the accompanying figures. Accordingly, those of ordinary skill in the art w recognize that various changes and modifications of the exemplary embodiments described herein can be made without departing from the spirit and scope the claimed invention. Descriptions of well-known functions and constructions are omitted for clarity and conciseness. Moreover, as used herein, the singular may be interpreted in the plural, and alternately, any term in the plural may be interpreted to be in the singular.

As briefly noted above the present invention is directed to high-rate settling clarifiers with increased turn-down capabilities. More specifically, the present invention is directed high-rate settling clarification treatment systems that may utilize multiple reactor vessels in fluidic communication with a single clarification/thickening vessel.

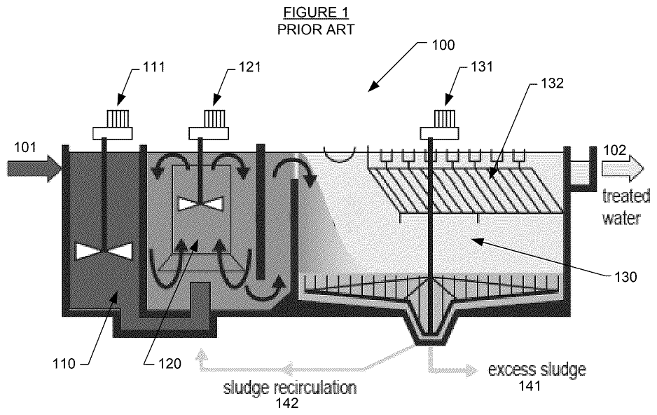

Before delving into the advantages of the present invention, it may first be useful to discuss current systems. With reference to FIG. 1, such a system 100—as generally known in the prior art—may comprise a flash mix zone 110, which may be mixed by mixer 111; a flocculation reactor 120, which may be mixed by mixer 121; and a clarification/settling zone 130. Sludge in the settling zone may be thickened using, for example, a floor scraper 131. Clarification may be assisted by lamellar modules 132. Excess sludge 141 may exit this system, while at least some sludge may be recirculated 142. The system 100 may generally receive an influent 101 and output a treated effluent 102.

In operation, raw water may enter flash mix zone 110, where a coagulant may be added, thereby causing agglomeration of colloidal particles within the raw water. Turbulence or stirring may be accomplished through the use of mixer 111. The fluid may then proceed to the flocculation reactor 120 the coagulated water may be brought into contact with a flocculating agent and thickened, recirculated sludge from the clarification/settling zone

130. This recirculated sludge may accelerate the flocculation process and assist in generating a dense and homogeneous floc.

The fluid may then transition to the clarification/settling zone 130. In some systems, the transition between the flocculation reactor 120 and the clarification/settling zone 130 may be accomplished through a piston reactor with an upward current. In the clarification/settling zone 130, floes may settle at the bottom of the tank due to their size and density. Clarified water may be separated from descending sludge and may rise through lamellar modules 132. Lamellae modules 132 may generally comprise small plates configured in a honeycomb pattern or other geometries, which may act as a refining stage trapping the lighter less dense so that have not settled.

Settled sludge may be progressively thickened at the bottom of the settling tank using a floor scraper 131. Part of the thickened sludge may be recycled to the coagulation and flocculation zone at 142, while any surplus may be ren d as excess sludge at 141.

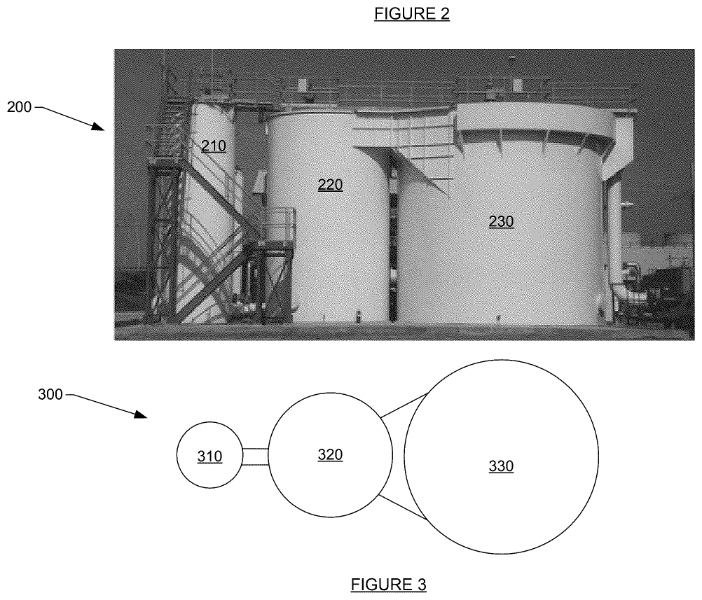

FIG. 2 illustrates an outside view of a system 200 as set forth in FIG. 1, generally comprising a coagulation zone or tank 210, a reactor zone or tank 220, and a clarification/thickener zone or tank 230. FIG. 3 depicts in graphic form what such a system 300 may appear from above, generally comprising a coagulation tank 310, a reactor tank 320, and a clarification/thickening tank 330.

As noted above, such systems may present a drawback as the are generally designed for maximum flow conditions. However, when it comes to designing a system for maximum flow, a controlling factor may be the reactor tank. The coagulation zone that provides a quick mix between the influent and a coagulant to cause agglomeration of colloidal particles is not as greatly limited by minimum or maximum flow. Similarly, the clarification/thickening zone is effective over a wide range of flow rates.

Accordingly, in order to provide for increased turndown rates in such systems, as well as to provide systems that may be modified over time to reach an anticipated (but not yet necessary) maximum flow rate, the inventors have created a system that utilizes multiple reactor zones with a single clarification/thickening zone. Having a single clarification/thickening zone may prevent the system from becoming septic or clogging or fouling due to sludge, as the clarification/thickening zone may be in continuous use. In addition, since the reactor zones or tanks may be in independent fluidic communication with the clarification/thickening zone, utilizing only one (1) reactor should not negatively impact any functionality of the overall system.

However, the installation and/or subsequent addition of multiple reactors is problematic. In general, the reactor vessel and the clarification/thickening vessels are mated together with a transfer chute. Water or wastewater exits the bottom of the reactor vessels, is brought up to towards the top of the vessel, and then introduced into the clarification/thickening vessel through a chute. The installation of multiple chutes presents concerns with the rigidity and structural integrity of the clarification thickening tank. In situations where additional reactor vessels may be subsequently added, punchouts may be positioned within the clarification/thickener vessel to provide quick installation without unforseen impacts to the tanks structure.

FIGS. 4-9 illustrate potential arrangements of systems in accordance with some embodiments of the present invention, as seen from a top view. Note that these figures do not depict the coagulation zone that is shown in FIGS. 1-3.

FIG. 4 illustrates a system 400 with a clarifier/thickener tank 410 in fluidic communication with reactors 420 and 430. In this arrangement tor 420, 430 may be positioned adjacent to each or may be spaced out.

With reference to FIG. 5, a system 500 in accordance with some embodiments of the present invention may comprise more than two (2) reactors. System 500 may comprise a clarifier/thickener tank 510, and three (3) reactors 520, 530, 540. Note that while these reactors are illustrated to be of the same size, it is contemplated by the present invention that the reactors may be of varying size and have varying treatment capabilities.

FIG. 6 illustrates a system 600 in which a clarifier/thickener vessel 610 may be in fluidic communication with four (4) reactors 620, 630, 640, 650. Reactors 620, 630 may be larger in size and treatment capability than reactors 640, 650. The inclusion of multiple reactors of different sizes may permit the operator with greater flexibility during treatment. In addition, such multiple reactors 620, 630, 640, 650 may have been sequentially added to the system 600 as the need for greater treatment capacity increased.

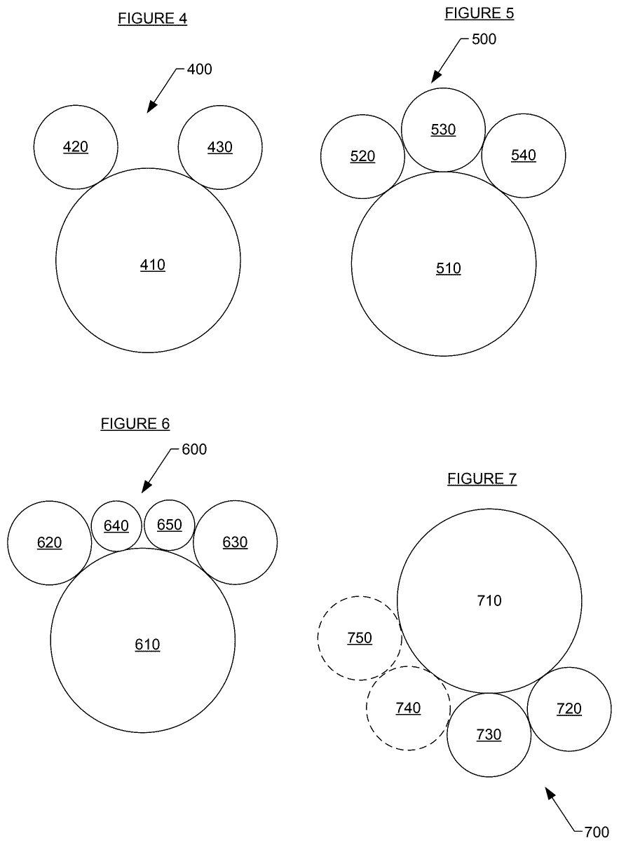

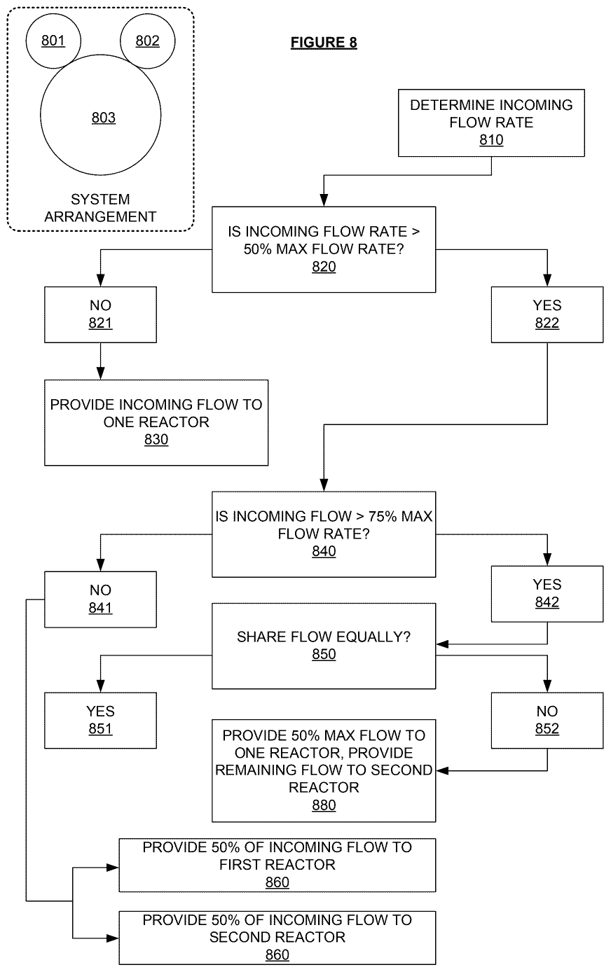

FIG. 7 depicts a system 700 that may comprise a clarifier/thickener tank 710 and two (2) current reactor vessels 720, 730. However, in this situation, it may be planned that additional reactors may be needed, so space may be reserved for future reactors 740, 750. In addition, knock-outs may be included in clarifier/thickener tank to assist in quick and efficient system expansion.

Note that the present invention provides operators with increased flexibility in multiple areas. First, as noted above, additional reactor tanks may provide with increased turndown by permitting the system to operate at lower flow rates. In circumstances where there is a large deviation between operational flow rates, different sized reactor tanks may be utilized. For example, in applications of sanitary sewer overflows or combined sewer overflows, climate condition may range from little to no rainfall, to large amounts of rainfall during wet seasons. In such applications, a system may need to achieve maximum flow of “X,” but may for nine (9) months out of the year only require a maximum flow rate of 0.25(X). In such conditions two (2) reactors may be installed—one with capacity to handled 0.75(X), the second to handle a maximum flow rate of 0.25(X). In this situation, during the dry season the smaller reactor can handle lower flow rates, while the larger reactor can be utilized during rainy seasons that may require near-maximum flow.

Such flexibility is not limited to two (2) reactors. It is contemplate the sent invention that circumstances may occur in which two (2), three (3), four (4), or even more reactors may be advantageous. Again, such reactors would be in communication with a single clarification/thickening tank. The use of such reactor tanks may be balanced based upon the amount of incoming flow.

For example, with reference to FIG. 8, a system may be present comprising a first reactor tank 801 and second reactor tank 802, each in fluidic communication with the clarification/thickener tank 803. Each reactor tank 801, 802 may be equally sized, and each configured to handle approximately fifty percent (50%) of the maximum flow for which the system was designed.

During operation, the incoming flow rate (or the desired flow rate of treatment) may be determined at 810. At 820 it may be determined if the incoming flow rate is greater than fifty percent (50%) of the maximum flow rate for which the system was designed. If this is answered in the negative at 821, then at 830 the full incoming flow (which is less than fifty percent (50%) of the systems maximum flow rate) may be provided to a single reactor—either 801 or reactor 802. the other reactor may remain inoperative.

If at 822 it is determined that the incoming rate is grater than fifty percent (50%) of the maximum flow rate for which the system is designed, there may be at least two (2) options. At 840 it may be determined if the incoming flow rate is less than seventy-five percent (75%) the maximum flow rate for which the system was designed, If so, then at 841 it may be determined that the incoming flow should be shared by both reactors 801, 802. This is because each reactor cannot effectively treat less than 50% its own maximum flow rate (due to aforementioned turbulence issues). Accordingly, the system may provide at 860 fifty percent (50%) of the incoming flow to the first reactor 801, and at 870 fifty percent (50%) of the incoming flow to the second reactor 802.

If it is determined at that the incoming flow rate is greater than seventy-five percent (75%) the maximum flow rate for which the system was designed at 842, then at 850 it may be determined if the incoming flow is to be equally shared by the reactors 801 802, or if one reactor should operate at a maximum capacity while the second reactor handles excess flow. If it is determined at 851 that the two reactors should equally share the incoming flow, then the system may provide at 860 fifty percent (50%) of the incoming flow to the first reactor 801, and at 870 fifty percent (50%) of the incoming flow to the second reactor 802.

If it is determined at 852 that one reactor should operate maximum capacity, then at 880 one (1) reactor (either 401 or 402) may receive an amount of incoming flow approximately equal to fifty percent (50%) of the flow rate for the was designed (or the maximum flow rate for which that reactor was designed). The remaining reactor may handle any excess flow.

Operators may be able to control the low rates to each of the reactors, allowing greater flexibility and variability in treatment.

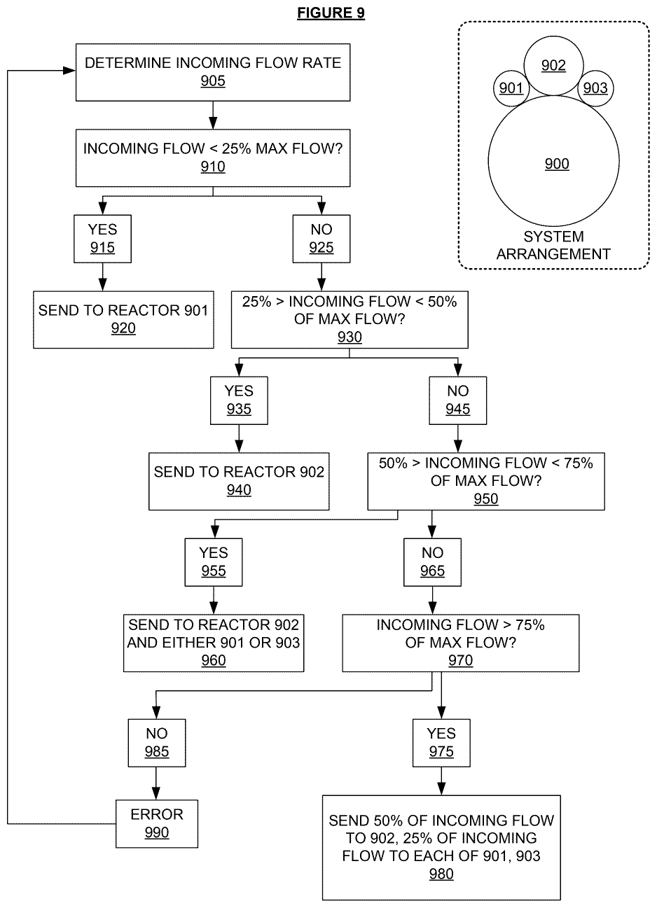

With reference to FIG. 9, a control process for a system comprising three (3) reactor tanks 901, 902, 903 in communication with one clarification/thickening tank 900 will now be discussed. In this scenario, there is one reactor 902 that is configured to handle approximately fifty percent (50%) of the maximum flow for which the overall system is designed. There are also two (2) smaller reactors 901, 903, each designed to handle up to twenty-five percent (25%) of the maximum flow for which the system is designed.

During operation, the incoming flow rate (or the desired rate of treatment) may be determined at 905. At 910 it may be determined if the incoming flow rate is less than twenty-five percent (25%) of the maximum flow rate. If it is so determined at 915, then at 920 the incoming flow may be sent to reactor 901. (Note that this could also be sent to reactor 903).

If it is determined at 925 that the incoming flow rate is greater than twenty-five-percent (25%) of maximum flow rate, then at 930 it may be determined if the incoming flow is greater than twenty-five percent (25%) but less than fifty percent (50%) maximum flow rate. If so determined at 935, the incoming flow may be sent to reactor 902 at 940.

If it is determined at 945 that the incoming flow rate is not between twenty-five and fifty percent (25-50%) of the maximum flow rate, then at 950 it may be determined if the flow rate is greater than fifty percent (50%) maximum flow rate, but less than seventy-five percent (75%). If so determined at 955, then at 960 the incoming flow may be reactor 902 and to either reactor 901 or 903.

If it is determined at 965 that the flow rate is not between fifty and seventy five percent (50-75%) of the maximum flow rate, then it may be determined if the incoming flow is greater than: seventy-five percent (75%) of the maximum flow rate. IF so determined at 975, then the incoming flow may be divided among the three reactors 901, 902, 903, with the larger reactor 902 receiving approximately fifty percent (50%) of the incoming flow, with the remaining flow divided among reactors 901, 903.

If it is determined at 985 that the incoming flow is not greater than seventy five percent (75%) maximum flow rate, then an error is determined at 990, and the process may revert back to step 905.

These examples are hypothetical and are intended to illustrate the flexibility of system processing and treatment utilizing multiple reactors connected with a single influent stream and a single clarification/thickener tank.

In addition to treatment flexibility, the present invention may also permit greater flexibility in the footprint of such treatment systems. The use of lamellar modules in such treatment systems alone is often attractive to operators, as such modules reduce the overall footprint of the clarification/thickening zone or tank. The ability to contour the system into limited or irregular footprints is also advantageous.

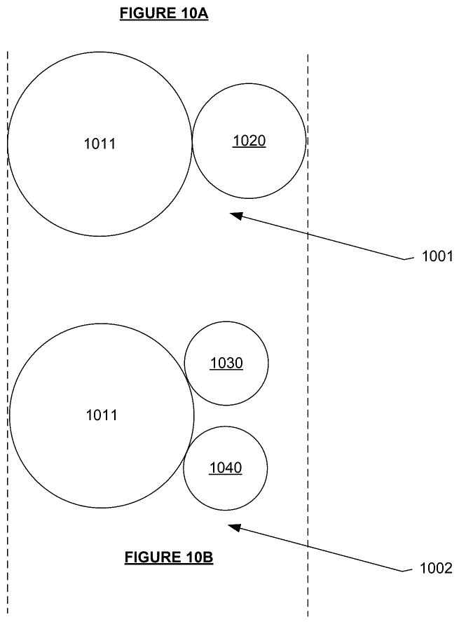

FIGS. 10A and 10B illustrate potential space savings using some embodiments of the present invention. FIG. 10A illustrates a system 1010 utilizing a clarifier/thickener vessel 1010 and a single reactor 1020. FIG. 10B illustrates a system 1002 utilizing a clarifier/thickener vessel 1011 with two (2) reactors 1030, 1040. The two reactors of FIG. 10B and the single reactor of FIG. 10A may provide equal treatment capabilities and maximum flow rates. However, the footprint of system 1002 is less than that of system 1001. This reduced footprint may be particularly valuable in retrofit situations where there is a need for increased capacity, but there is not increased space available to support capacity.

In addition to the advantages discussed above, the present invention may also reduce operating expenses of such water treatment systems. Comparing a first scenario of a clarifier/thickener vessel with a single reactor and a second scenario with a clarifier/thickener vessel and two small reactors, during low flow times the energy required to operate a single smaller reactor may be less than the energy required to operate the single large reactor. This may be due to the reduced size of the reactor turbine drive that may be used to agitate the fluid to stir and cause turbulence thereto. The maximum energy draw of a system may then correspond with the maximum flow of a system. In other words, when the operating flow rate is lower, the operating expenses may also be lower.

It will be understood that the specific embodiments of the present invention shown and described herein are exemplary only. Numerous variations, changes, substitutions and equivalents will now occur to those skilled in the art without departing from the intent of the invention. Accordingly, it is intended that all subject matter described herein and shown in the accompanying drawings be regarded as illustrative only, and not in a limiting sense.

What is claimed is:

1. A system for the treatment of water or wastewater, comprising:
two or more reactor tanks, each reactor tank being fluidically connected to a clarification tank, the reactor tanks each performing the same function of receiving an influent and inducing flocculation in the water or wastewater, and outputting an effluent;
the clarification tank, said clarification tank receiving the effluent from the two or more reactor tanks, wherein flocs in the water or wastewater settle to the bottom of the clarification tank and thickened sludge and clarified water are removed from the system.

2. The system of claim 1, further comprising a coagulation tank in fluid communication with the two or more reactor tanks, the coagulation tank providing introduction of a coagulant to the water or wastewater and mixing.

3. The system of claim 1, wherein each two or more reactor tanks comprise a means for inducing turbulence into the water of wastewater in each reactor tank.

4. The system of claim 1, wherein the clarification tank comprises a floor scraper to thicken flocs that have settled to the bottom of the clarification tank into sludge.

5. The system of claim 4, wherein at least some of the sludge is recirculated to the two or more reactor tanks.

6. The system of claim 1, wherein the clarification tank comprises sloping lamellae.

7. The system of claim 1, wherein each of the two or more reactor tanks is fluidically connected to the clarification tank by a transition chute.

8. A system for the treatment of water or wastewater, wherein the system is designed for a maximum flow rate, the system comprising:
two or more reactor tanks, the two or more reactor tanks each having a capability less than the maximum flow rate, and having a combined capability of achieving or exceeding the maximum flow rate, each reactor tank being fluidically connected to a clarification tank, the reactor tanks receiving an influent, and outputting an effluent;
the clarification tank designed to achieve or exceed the maximum flow rate, the clarification tank receive the effluent from the two or more reactor tanks.

9. The system of claim 8, wherein the two or more reactor tanks each perform the same function of inducing flocculation in the water or wastewater, and wherein in the clarification tank flocs in the water or wastewater settle to the bottom of the clarification tank and clarified water and thickened sludge is removed from the system.

10. A system for the treatment of waste or wastewater, wherein in the system is designed for a maximum flow rate, the system comprising:
a coagulation tank in fluid communication with two or more reactor tanks, the coagulation tank providing introduction of a coagulant to the water or wastewater and mixing;
two or more reactor tanks, the two more reactor tanks each having a capability less than the maximum flow rate, and having a combined capability of achieving or exceeding the maximum flow rate, each reactor tank being fluidically connected to a clarification tank via a transition chute and each reactor tank comprising a means for inducing turbulence to the water or wastewater, the reactor tanks each performing the same function of receiving an influent and inducing flocculation in the water or wastewater and outputting an effluent;
a clarification tank having a capability to process water or wastewater at or above the maximum flow rate, the clarification tank receiving the effluent from the two or more reactor tanks, wherein flocs in the water or wastewater settle to the bottom of the clarification tank and clarified water is removed from the system, the clarification tank comprising sloping lamella and a floor scraper to thicken flocs that have settled to the bottom of the clarification tank into sludge
a sludge recirculation conduit configured to recirculate at least some of the sludge from the clarification tank to the two or more reactor tanks.

11. A method of controlling a system for the treatment of water or wastewater designed for a maximum flow rate, the system comprising two reactor tanks each having a capability less than the maximum flow rate, and having a combined capability of achieving or exceeding the maximum flow rate and a clarification tank having a capability to process water or wastewater at or above the maximum flow rate, the method comprising:
determining the incoming flow rate of an influent provided to the system;
upon a determination that the incoming flow rate is less than 50% the maximum flow rate, providing the influent to one reactor tank;
upon a determination that the incoming flow rate is greater than 50% the maximum flow rate, dividing the influent and providing influent to each of the reactor tanks;
outputting an effluent from the reactor tank or tanks used to a clarification tank;
receiving at a clarification tank the effluent from the reactor tank or tanks used and outputting treated water or wastewater and thickened sludge from the system.
